(19) United States
(12) Patent Application Publication
(10) Pub. No.: US 2022/0124388 A1
(43) Pub. Date: Apr. 21, 2022

(54) IMAGE DISPLAY DEVICE

(71) Applicant: REALTEK SEMICONDUCTOR CORPORATION, Hsinchu (TW)

(72) Inventor: YU-CHANG TSAI, Hsinchu (TW)

(21) Appl. No.: 17/500,980

(22) Filed: Oct. 14, 2021

(30) Foreign Application Priority Data
Oct. 19, 2020 (TW) 109136171

(51) Int. Cl. H04N 21/234; H04N 21/431

(52) U.S. Cl. CPC H04N 21/23418; H04N 21/431

(57) ABSTRACT

A device includes a scaler circuitry and a translator circuitry. The scaler circuitry is configured to perform an image processing on video data for generating a first signal. The translator circuitry includes a plurality of output ports and is configured to convert the first signal to be at least one second signal and output the at least one second signal via at least one of the plurality of output ports. The plurality of output ports correspond to a plurality of display interfaces respectively, and the plurality of display interfaces are different from each other.

### BACKGROUND OF THE INVENTION

### 1. Field of the Invention

The present disclosure relates to an image display device. More particularly, the present disclosure relates to an image display device that supports multimonitor via a traditional display interface and/or multi-stream transport.

### 2. Description of Related Art

With development of technology, more and more standards and/or types of display interfaces are purposed, in order to support higher data transfer rate and high-speed display applications. In existing signal interfaces, in order to support multi-stream transport (MST) or a daisy chain, each monitor is required to have a specific signal interface. If an existing monitor does not have the specific signal interface, the existing monitor is unable to support MST or the daisy chain. As a result, the existing monitor is required to be discarded and replaced by new monitors that have the specific signal interface, which results in unnecessary electronic waste and additional cost for purchasing the new monitors.

### SUMMARY OF THE INVENTION

In some aspects of the present disclosure, a device includes a scaler circuitry and a translator circuitry. The scaler circuitry is configured to perform an image processing on video data for generating a first signal. The translator circuitry includes a plurality of output ports and is configured to convert the first signal to be at least one second signal and output the at least one second signal via at least one of the plurality of output ports. The plurality of output ports correspond to a plurality of display interfaces respectively, and the plurality of display interfaces are different from each other.

In some aspects of the present disclosure, a device includes a scaler circuitry. The scaler circuitry is configured to perform an image processing on video data, in order to generate a first signal. The translator circuity is configured to convert the first signal to be at least one second signal. The port controller circuitry is configured to convert the at least one second signal to be a third signal and output the third signal via a universal serial bus type-C interface, in order to support multi-stream transport.

These and other objectives of the present disclosure will be described in preferred embodiments with various figures and drawings.

### BRIEF DESCRIPTION OF THE DRAWINGS

FIG. 1 is a schematic diagram of an image display device according to some embodiments of the present disclosure.

FIG. 2 is a schematic diagram of the scaler circuitry in FIG. 1 according to some embodiments of the present disclosure.

FIG. 3 is a schematic diagram of the translator circuitry in FIG. 1 according to some embodiments of the present disclosure.

FIG. 4 is a schematic diagram of an image display device according to some embodiments of the present disclosure.

FIG. 5 is a schematic diagram of the port controller circuitry in FIG. 4 according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuitry” may indicate a system formed with one or more circuits. The term “circuit” may indicate an object, which is formed with one or more transistors and/or one or more active/passive elements based on a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, like elements in various figures are designated with the same reference number.

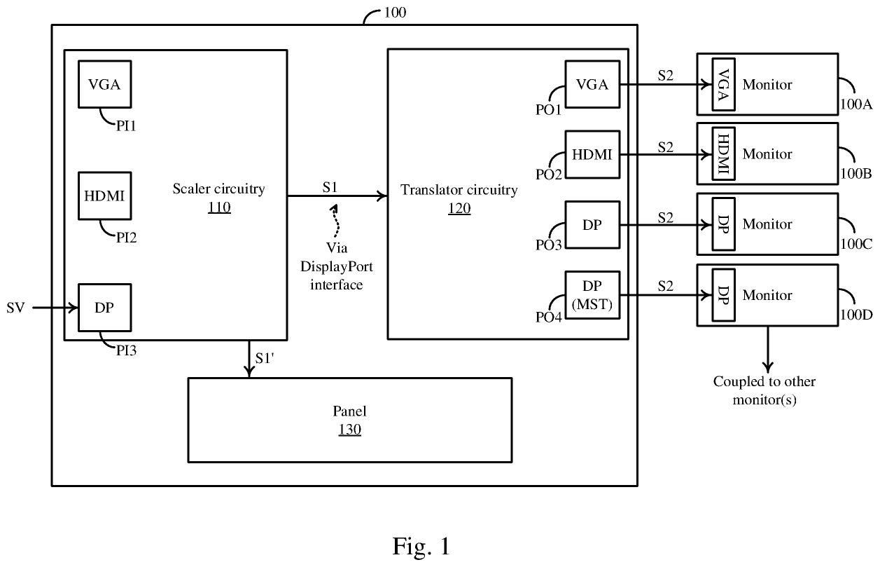

FIG. 1 is a schematic diagram of an image display device 100 according to some embodiments of the present disclosure. In some embodiments, the image display device 100 may be, but not limited to, a computer monitor, a television, a mobile display, and so on. In some embodiments, the image display device 100 includes a scaler circuitry 110 and a translator circuitry 120. In some embodiments, each of the scaler circuitry 110 and the translator circuitry 120 may be a chip. In some embodiments, the scaler circuitry 110 and the translator circuitry 120 may be integrated in a single chip.

In this example, the scaler circuitry 110 includes input ports PI1-PI3, which correspond to different signal interfaces respectively. For example, the input port PI1 may be a video graphic array (VGA) interface, the input port PI2 is a high definition multimedia interface (HDMI), and the input port PI3 is a DisplayPort interface (labeled as DP). The scaler circuitry 110 may receive video data SV from a signal source (not shown in figures) from one of the input ports PI1-PI3 (which may be, but not limited to, the input port PI3), and perform an image processing on the video data SV to generate a signal S1. In some embodiments, the aforementioned signal source may be, but not limited to, a computer, a video player, a mobile phone, and so on.

A number of the input port PI1-PI3 and types of signal interfaces are given for illustrative purposes, and the present disclosure is not limited thereto. In some embodiments, the scaler circuitry 110 may include one or more input ports. In some other embodiments, the scaler circuitry 110 at least includes the input port PI3.

In some embodiments, the image display device 100 further includes a panel 130, which may show a corresponding image according to a signal S1′ associated with the signal S1. In some embodiments, the signal S1 includes video (and/or audio) data that is to be displayed by the image display device 100 and video (and/or audio) data that is to be displayed by other device(s) (e.g., monitors 100A-100D). In some embodiments, the display 100A is coupled to an output port PO1 via a VGA interface, the monitor 100B is coupled to an output port PO2 via a HDMI, the monitor 100C is coupled to an output port PO3 via a DisplayPort interface (labeled as DP), and the monitor 100D is coupled to an output port PO4 via a DisplayPort interface (labeled as DP). In some embodiments, the signal S1′ may be a portion of the signal S1 or identical to the signal S1. The panel 130 may display the corresponding image based on the signal S1′. In some embodiments, the panel 130 may be, but not limited to, a backlight panel or a panel using light-emitting diode(s) (LEDs). For example, backlight panel may be, but not limited to, a twisted nematic panel, a super twisted nematic panel, a thin film transistor panel, or the like. The panel using LEDs is a device that displays image(s) through a LED matrix. For example, the panel using LEDs may be, but not limited to, a Micro LED panel, a mini LED panel, an OLED panel, or the like.

The translator circuitry 120 is coupled to the scaler circuitry 110 via a DisplayPort interface. As a result, the scaler circuitry 110 may transmit the signal S1 to the translator circuitry 120 via the DisplayPort interface. The translator circuitry 120 may convert the signal S1 to be signals S2. In some embodiments, the translator circuitry 120 may include the output ports PO1-PO4, which correspond to different display interfaces. For example, the output port PO1 is a VGA interface, the output port PO2 is HDMI, the output port PO3 is a DisplayPort interface (labeled as DP), and the output port PO4 is a DisplayPort interface that supports multi-stream transport (MST) (labeled as DP(MST)). In other words, the signal S2 outputted from the output port PO4 supports MST. The translator circuitry 120 may output the signals having different formats via the output ports PO1-PO4 respectively, in order to drive the monitors 100A-100D having different interfaces (i.e., VGA interface, HDMI, DisplayPort interface) to show corresponding images. As a result, the image display device 100 may be coupled to the monitors 100A-100D in series, in order to show images that are independent to (and/or partially related to) each other. In some embodiments, the image display device 100 may be coupled to one or more monitors and the monitor 100D via the output port PO4 that supports MST, in order to form a daisy chain topology. In some embodiments, the image display device 100, the monitors 100A-100D having different interfaces, and/or at least one monitor that is coupled to the monitor 100D may form a television wall.

A number of the output ports PO1-PO4 and the types of aforementioned signal interfaces are given for illustrative purposes, and the present disclosure is not limited thereto. In some embodiments, the translator circuitry 120 may include at least one of the output ports PO1-PO4. In some embodiments, according to requirements of practical applications, the number of output ports in the translator circuitry 120 may be adjusted correspondingly.

In some related approaches, in order to support MST, a signal interface of an image display device is required to be fully compatible with DisplayPort 1.2 or its successor version. However, the existing image display device is commonly not equipped with a DisplayPort interface, or a version of the DisplayPort interface thereof is too old and is thus unable to support MST. In order to achieve a multimonitor application, the existing required image display devices are required to be replaced by new monitors that support MST. As a result, unnecessary electronic waste and additional costs are caused. Compared with these approaches, in some embodiments of the present disclosure, with the translator circuitry 120, the image display device 100 is able to support multiple display interfaces, in order to couple current monitors in series. Meanwhile, the image display device 100 also has the connection port PO4 that supports MST, in order to couple monitor(s) having a successor version of the DisplayPort interface in series.

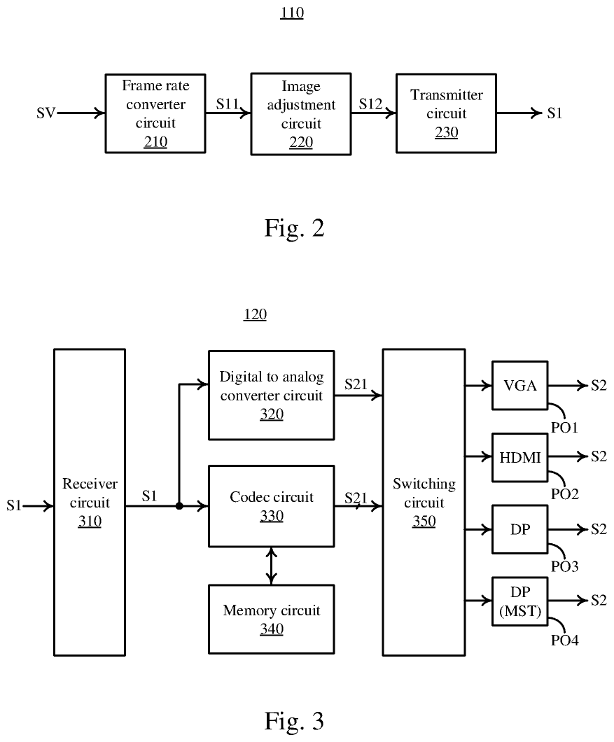

FIG. 2 is a schematic diagram of the scaler circuitry 110 in FIG. 1 according to some embodiments of the present disclosure. In this example, the scaler circuitry 110 includes a frame rate converter circuit 210, an image adjustment circuit 220, and a transmitter circuit 230. The frame rate converter circuit 210 receives the video data SV via one of the input ports PO1-PO3 in FIG. 1 and performs a frame rate conversion according to the video data SV to generate a signal S11. For example, the frame rate converter circuit 210 sequentially writes multiple frame data in the video data SV to a memory (not shown in figures), and sequentially reads these frame data from the memory at required timings and outputs the same to be the signal S11. The image adjustment circuit 220 is configured to perform a color processing and/or a size scaling operation on image data carried in a signal S21, in order to generate a signal S12. The transmitter circuit 230 is a data transmission circuit that supports DisplayPort interface. The transmitter circuit 230 may be configured to output the signal S12 to be the signal S1. In some embodiments, each of the frame rate converter circuit 210 and the image adjustment circuit 220 may be implemented with a digital signal processor circuit. In some embodiments, the frame rate converter circuit 210 and the image adjustment circuit 220 may be integrated into a single image processor circuit.

The above arrangements about the scaler circuitry 110 are given for illustrative purposes, and the present disclosure is not limited thereto. For example, in other embodiments, the image adjustment circuit 220 may generate the signal S11 according to the video data SV, and the frame rate converter circuit 210 may generate the signal S12 according to the signal S11. In some embodiments, the scaler circuitry 110 may further include an overdrive circuit (not shown in figures), which is configured to perform a video compensation on the signal S12 (or the signal S1), in order to avoid a motion blur on the displayed images.

FIG. 3 is a schematic diagram of the translator circuitry 120 in FIG. 1 according to some embodiments of the present disclosure. In some embodiments, the translator circuitry 120 includes a receiver circuit 310, a digital to analog converter circuit 320, a codec circuit 330, a memory circuit 340, and a switching circuit 350.

The receiver circuit 310 is a data receiver circuit that supports the DisplayPort interface. The receiver circuit 310 is coupled to the transmitter circuit 230 in FIG. 2 to receive the signal S1. In some embodiments, the receiver circuit 310 may transmit image data in the signal S1 to the digital to analog converter circuit 320, and the digital to analog converter circuit 320 may convert the image data in the signal S1 to be one of signals S21 (which may be outputted from the output port PO1). The memory circuit 340 stores requirements of multiple interfaces (e.g., HDMI, DisplayPort interface, and DisplayPort interface that supports MST). The codec circuit 330 is coupled to the memory circuit 340 and the receiver circuit 310. The codec circuit 330 may perform a corresponding codec operation to the signal S1 based on the requirements stored in the memory circuit 340, in order to convert the signal S1 to be remaining signals in the signals S21 that meet requirements of corresponding interfaces. The switching circuit 350 is configured to output the signals S21 to be signals S2 via the output ports PO1-PO4 in FIG. 1.

In some embodiments, the codec circuit 330 may be implemented with digital logic circuits. In some embodiments, the codec circuit 330 may be implemented with a digital signal processor circuit. In some embodiments, the switching circuit 350 may be implemented with multiple switches, which are configured to set an output path of the signals S21. The arrangements of the translator circuitry 120 are given for illustrative purposes, and the present disclosure is not limited thereto.

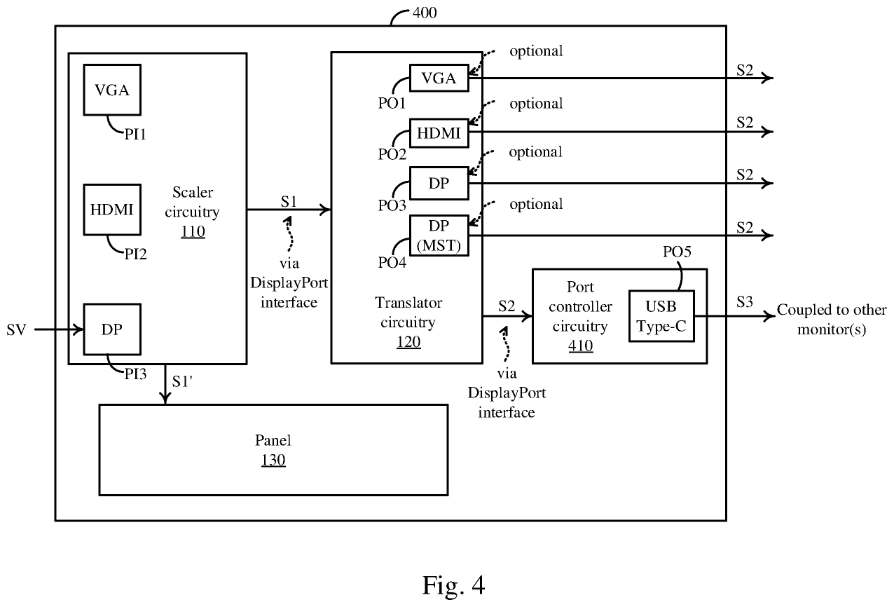

FIG. 4 is a schematic diagram of an image display device 400 according to some embodiments of the present disclosure. Compared with the image display device 100 in FIG. 1, the image display device 400 further includes a port controller circuitry 410. The port controller circuitry 410 includes an output port PO5. In some embodiments, the output port PO5 may be a universal serial bus (USB) interface. For example, the output port PO5 may be a USB Type-C interface that supports MST. In this example, the translator circuitry 120 transmits at least one signal S2 to the port controller circuitry 410 via the DisplayPort interface. The port controller circuitry 410 may convert the signal to be a signal S3 that meets requirements of USB type-C standard, and output the signal S3 to a monitor (not shown) via the output port PO5, in order to drive the monitor to show a corresponding image. In other words, compared with the image display device 100, the image display device 400 further includes the output port PO5 that is implemented with a USB type-C interface, in order to support different types of monitors.

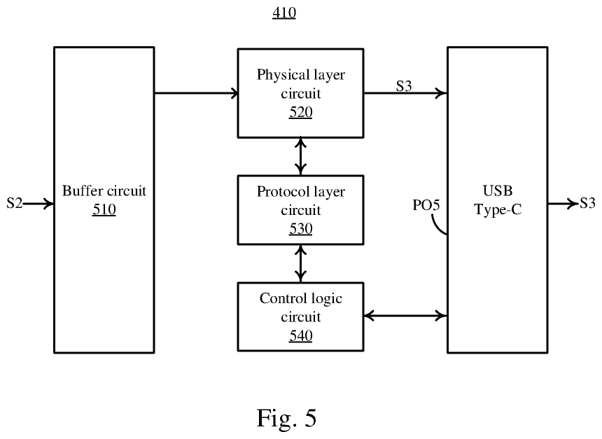

FIG. 5 is a schematic diagram of the port controller circuitry 410 in FIG. 4 according to some embodiments of the present disclosure. In this example, the port controller circuitry 410 includes a buffer circuit 510, a physical layer circuit 520, a protocol layer circuit 530, and a control logic circuit 540. The buffer circuit 510 is configured to receive the at least one signal S2 from the translator circuitry 120 in FIG. 4 via the DisplayPort interface. The protocol layer circuit 530 is configured to detect a connection error (e.g., monitoring response(s) from the physical layer circuit 520, monitoring the connection message, determining whether to reset, and so on). The physical layer circuit 520 is configured to convert the at least one signal S2 to be the signal S3 and output the signal S3 via the output port PO5. For example, the physical layer circuit 520 may include, but not limited to, a receiver circuit (not shown), a parallel to serial converter circuit (not shown), and a transmitter circuit (not shown). The receiver circuit may be configured to receive the at least one signal S2, the parallel to serial converter circuit may convert the at least one signal S2 to be the signal S3, and the transmitter circuit may transmit the signal S3 to the output port PO5. The control logic circuit 540 may be configured to detect a configuration channel pin in the output port PO5 and transmit detected information to the protocol layer circuit 530.

The detailed configurations about the above circuits in the port controller circuitry 410 can be understood with reference to the specification of USB type-C, and thus the repetitious descriptions are not given. The above implementations of the port controller circuitry 410 are given for illustrative purposes, and the present disclosure is not limited thereto.

It is understood that, arrangements of the image display device 100 in FIG. 1 and those of the image display device 400 in FIG. 4 may be adjusted according to practical applications. Therefore, in some embodiments, the image display device 100 (or the image display device 400) may include at least one of VGA interface, HDMI, or DisplayPort interface and at least one of output ports that supports MST or USB type-C.

As described above, with the image display device in some embodiments of the present disclosure, it is able to achieve multi-monitors or TV wall applications by utilizing existing monitor(s) that do not support MST. As a result, these existing monitors are not required to be discarded, which results in lower amount of electronic waste and lower costs of purchasing new monitors.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely some embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. A device, comprising:
a scaler circuitry configured to perform an image processing on video data for generating a first signal; and
a translator circuitry comprising a plurality of output ports and configured to convert the first signal to be at least one second signal and output the at least one second signal via at least one of the plurality of output ports,
wherein the plurality of output ports correspond to a plurality of display interfaces respectively, and the plurality of display interfaces are different from each other.

2. The device of claim 1, wherein the scaler circuitry is configured to transmit the first signal to the translator circuitry via a DisplayPort interface.

3. The device of claim 1, further comprising:
a panel configured to show a first image according to a signal associated with the first signal,
wherein the at least one second signal is configured to be outputted to at least one monitor via at least one of the plurality of output ports, in order to drive the at least one monitor to show at least one second image.

4. The device of claim 1, wherein the plurality of output ports comprise a video graphic array interface.

5. The device of claim 1, wherein the plurality of output ports comprise a high definition multimedia interface.

6. The device of claim 1, wherein the plurality of output ports comprise a first output port and a second output port, each of the first output port and the second output is a DisplayPort interface, and the at least one signal outputted from one of the first output port and the second output port is configured to support multi-stream transport.

7. The device of claim 1, further comprising:
a port controller circuitry configured to convert the at least one second signal to be a third signal and output the third signal via a universal serial bus interface.

8. The device of claim 7, wherein the universal serial bus interface is a universal serial bus type-C interface.

9. The device of claim 7, wherein the translator circuitry is configured to transmit the at least one second signal to the port controller circuitry via a DisplayPort interface.

10. A device, comprising:
a scaler circuitry configured to perform an image processing on video data, in order to generate a first signal;
a translator circuity configured to convert the first signal to be at least one second signal; and
a port controller circuitry configured to convert the at least one second signal to be a third signal and output the third signal via a universal serial bus type-C interface, in order to support multi-stream transport.

11. The device of claim 10, wherein the translator circuitry comprises:
a plurality of output ports corresponding to a plurality of display interfaces respectively,
wherein the plurality of display interfaces are different from each other, and the translator circuitry is configured to output the at least one second signal to a monitor via at least one of the plurality of output ports.

12. The device of claim 11, wherein the plurality of output ports comprise a video graphic array interface.

13. The device of claim 11, wherein the plurality of output ports comprise a high definition multimedia interface.

14. The device of claim 11, wherein the plurality of output ports comprise a first output port and a second output port, each of the first output port and the second output is a DisplayPort interface, and the at least one signal outputted from one of the first output port and the second output port is configured to support the multi-stream transport.

15. The device of claim 10, wherein the scaler circuitry is configured to transmit the first signal to the translator circuitry via a DisplayPort interface.

16. The device of claim 10, wherein the translator circuitry is configured to transmit the at least one second signal to the port controller circuitry via a DisplayPort interface.
